(19) United States
(12) Patent Application Publication
(10) Pub. No.: US 2024/0365237 A1
(43) Pub. Date: Oct. 31, 2024

(54) SYSTEMS, METHODS, AND DEVICES FOR LOW-POWER SECURE WAKEUP OPERATIONS FOR WIRELESS DEVICES

(71) Applicant: Cypress Semiconductor Corporation, San Jose, CA (US)

(72) Inventors: Daniel LEE, Salt Lake City, UT (US); Ajinder Pal SINGH, Allen, TX (US)

(73) Assignee: Cypress Semiconductor Corporation, San Jose, CA (US)

(21) Appl. No.: 18/513,266

(22) Filed: Nov. 17, 2023

Related U.S. Application Data
(60) Provisional application No. 63/498,964, filed on Apr. 28, 2023.

(51) Int. Cl. H04W 52/02

(52) U.S. Cl. CPC H04W 52/0251

(57) ABSTRACT

Systems, methods, and devices provide low-power wakeup operations for wireless devices. Methods include receiving an audio signal from a first wireless device at a second wireless device via an audio transducer, the audio signal including a plurality of encoded data values, and determining, using a processing device of the second wireless device, if the received audio signal includes a valid wakeup code. Methods also include transitioning a transceiver of the second wireless device from a sleep mode to a wake mode in response to determining that the audio signal includes a valid wakeup signal.

### TECHNICAL FIELD

This disclosure relates to wireless devices, and more specifically, to enhancement of power consumption associated with such wireless devices.

### BACKGROUND

Wireless environments may include various different types of wireless devices configured to communicate with each other via one or more wireless connections. Such wireless devices may be used for security and authentication operations. Wireless devices may also have different hardware and power consumption capabilities. For example, some wireless devices may have robust power supplies while others may be constrained by an amount of available power, and may thus be configured as low-power devices. Conventional wireless environments remain limited because they often use additional hardware resources having higher power consumption rates for security and authentication operations.

### BRIEF DESCRIPTION OF THE DRAWINGS

FIG. 1 illustrates an example of a system for low-power wakeup operations, configured in accordance with some embodiments.

FIG. 2 illustrates an example of a device for low-power wakeup operations, configured in accordance with some embodiments.

FIG. 3 illustrates an example of a method for low-power wakeup operations, performed in accordance with some embodiments.

FIG. 4 illustrates another example of a method for low-power wakeup operations, performed in accordance with some embodiments.

FIG. 5 illustrates an additional example of a method for low-power wakeup operations, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless environments may include wireless devices configured to communicate with each other via various different wireless modalities. For example, a wireless environment may include various devices implemented in a vehicle, such as an automobile. Accordingly, the automobile may have an infotainment system and a head unit included in that infotainment system. Moreover, the head unit may include one or more transceivers capable of wireless communication with other wireless devices. For example, the head unit may communicate with a wireless key fob to enable wireless authentication operations which may allow or disallow access to the automobile. Such key fobs may be designed to have batteries that last multiple years, and thus have low-power consumption constraints.

In one example, one or more components of the key fob enter a sleep mode when not needed, and may be woken up when needed. Accordingly, components, such as transceivers, included in the key fob may be set to a sleep mode when the key fob is not near the automobile, and when such secure ranging operations are not needed. However, additional hardware resources may remain awake for the purposes of such proximity detection. For example, conventional techniques may include a dedicated low-frequency transponder and antenna array that are used for proximity detection which may be used to trigger wakeup operations and secure ranging operations. These additional hardware resources consume additional power even when other components are set to a sleep mode, and they reduce the efficiency of such wireless devices.

Embodiments disclosed herein provide low-power communication and wakeup operations for wireless devices. As will be discussed in greater detail below, a wireless device, such as a key fob, may be configured to include a passive transducer that is configured to receive an audio signal. In various embodiments, passive transducers may be devices such as microphones, and may be microelectromechanical systems (MEMS) devices. Moreover, processing logic of the key fob may be configured to decode the received audio signal to determine if wakeup operations should be performed to wakeup other components of the key fob, such as one or more additional transceivers used for ranging operations. In this way, power consumption of components used to trigger wakeup operations may be reduced, and overall efficiency of the wireless device is improved.

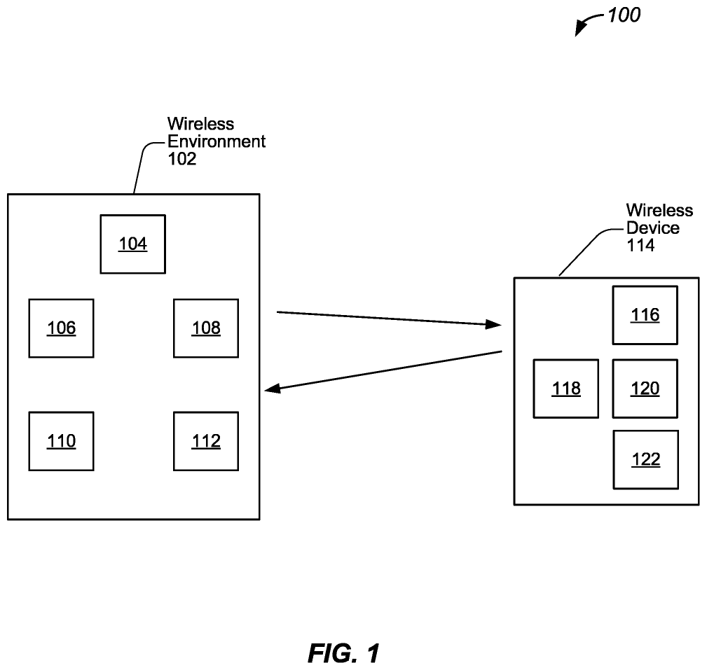

FIG. 1 illustrates an example of a system for low-power wakeup operations, configured in accordance with some embodiments. Systems, such as system 100, may include various wireless devices configured to perform security and authentication operations that may be used to, for example, grant or deny access to a particular operational environment associated with such wireless devices. As will be discussed in greater detail below, such wireless devices may be used to perform operations underlying the grant or denial of access to vehicles, such as automobiles.

Thus, according to some embodiments, system 100 includes wireless environment 102 which may be an operational environment in which one or more wireless devices are implemented. For example, wireless environment 102 may be an automobile. In this example, wireless environment 102 may include various wireless devices, such as head unit 104 which may be part of an infotainment system of the automobile. In some embodiments, head unit 104 is configured as a multi-band wireless device and includes multiple collocated transceivers compatible with multiple communications protocols. For example, head unit 104 may include a transceiver compatible with a Wi-Fi protocol, a transceiver compatible with a Bluetooth protocol, and a transceiver compatible with a UWB protocol. Accordingly, head unit 104 may be configured to communicate with wireless devices implemented within wireless environment 102, and may also be configured to support access point functionalities and communicate with wireless devices outside of wireless environment 102. In some embodiments, head unit 104 may include a single transceiver. A number and configuration of transceivers included in head unit 104 may be determined based on ranging operations used by system 100.

In various embodiments, wireless environment 102 further includes one or more audio transducers, such as transducer 106, transducer 108, transducer 110, and transducer 112. In various embodiments, such transducers are configured to emit an audio signal, and are also configured to receive an audio signal. The audio signal may have a frequency outside of an audible range of a human, such as 22 KHz. In one example, the transducers may be included in a sonar system of the automobile and may be used for user functions, such as parking assistance. Accordingly, the transducers may be communicatively coupled to head unit 104 which may include a processing device configured to handle processing operations for such sonar functionality as well as audio signal generation. As will be discussed in greater detail below, head unit 104 and one or more of transducer 106, transducer 108, transducer 110, and transducer 112 may be configured to emit an audio signal used for low-power wakeup operations, as disclosed herein.

Accordingly, system 100 additionally includes wireless device 114 which is configured to communicate with one or more components of wireless environment 102. In some embodiments, wireless device 114 is a key fob that is associated with the automobile associated with wireless environment 102. In various embodiments, wireless device 114 includes processing device 118 as well as transceiver 116, transceiver 120, and transducer 122. As will be discussed in greater detail below, transducer 122 may be a passive transducer configured to receive an audio signal generated by one or more of transducer 106, transducer 108, transducer 110, and transducer 112. In one example, transducer 122 may be included in fabricated package, such as a MEMS device. Accordingly, transducer 112 may be configured to receive an audio signal from wireless environment 102, and may be configured to determine if one or more other components, such as other transceivers, should be woken up based on the received audio signal.

As will be discussed in greater detail below, the other transceivers, such as transceiver 116 and transceiver 120, may be configured to be compatible with protocols such as Bluetooth and ultrawideband (UWB). Accordingly, once woken up, such transceivers may be used for additional operations, such as secure ranging with the automobile. In this way, a passive transducer may be used to manage wakeup operations and secure ranging operations, and reduce overall power consumption of wireless device 114 when various components are in a sleep mode and waiting to be woken up.

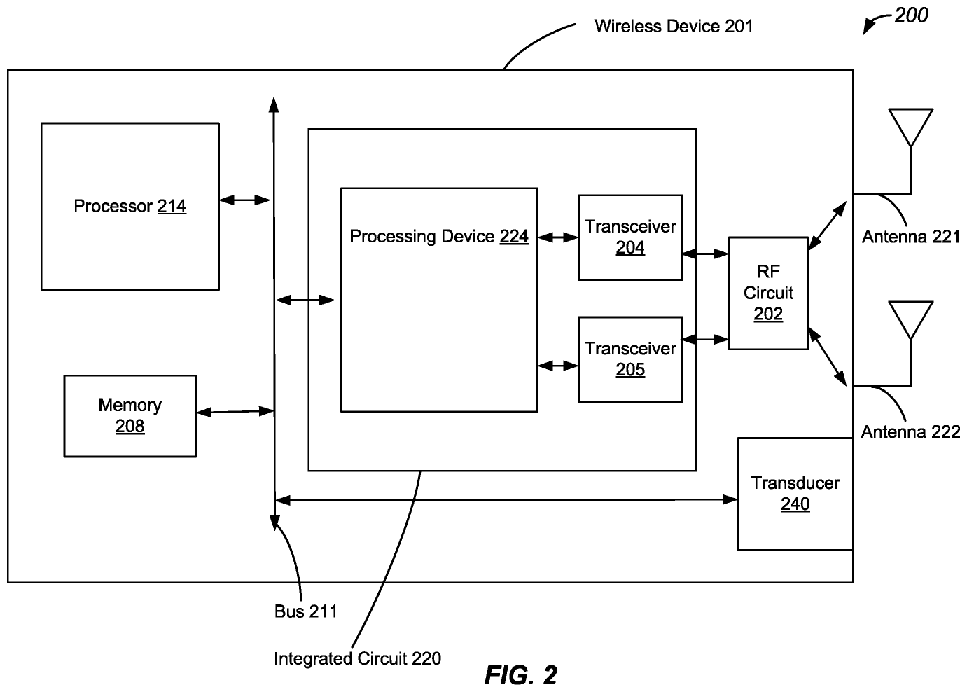

FIG. 2 illustrates an example of a device for low-power wakeup operations, configured in accordance with some embodiments. More specifically, FIG. 2 illustrates an example of a system, such as system 200, that may include wireless device 201. It will be appreciated that wireless device 201 may be one of the wireless devices discussed above with reference to FIG. 1, such as wireless device 114.

In various embodiments, wireless device 201 includes one or more transceivers, such as transceiver 204 and transceiver 205. In one example, system 200 includes transceiver 204 which is configured to transmit and receive signals using a communications medium that may include antenna 221 or antenna 222. As noted above, transceiver 204 may be a UWB transceiver. Accordingly, transceiver 204 may be compatible with an ultrawideband communications protocol. In various embodiments, transceiver 204 includes a modulator and demodulator as well as one or more buffers and filters, which are configured to generate and receive signals via antenna 221 and/or antenna 222.

System 200 additionally includes transceiver 205 which may be collocated with transceiver 204 in wireless device 201. In various embodiments, transceiver 205 is also configured to transmit and receive signals using a communications medium that may include antenna 221 or antenna 222. Accordingly, transceiver 205 may be a Bluetooth transceiver compatible with a Bluetooth communications protocol, which may be a Bluetooth Low Energy (BLE) protocol. Moreover, transceiver 205 includes a modulator and demodulator as well as one or more buffers and filters, which are configured to generate and receive signals via antenna 221 and/or antenna 222. While various embodiments are described with reference to a Bluetooth communications protocol, it will be appreciated that any suitable protocol may be used.

In various embodiments, system 200 further includes one or more processing devices, such as processing device 224 which may include logic implemented using one or more processor cores. Accordingly, processing device 224 is configured to implement logic for audio signal processing operations, as will be discussed in greater detail below. For example, processing device 224 may be configured to perform signal detection and validation operations for audio signals received via a transducer, such as transducer 240. Accordingly, processing device 224 includes processing elements configured to perform the audio detection and validation operations based on signals received via transducer 240. As will be discussed in greater detail below, transducer 240 may be a passive device, such as a MEMS microphone, and may be configured to detect an audio signal emitted from an entity, such as an automobile, at a designated frequency. Transducer 240 is communicatively coupled to processing device 224 via one or more components, such as bus 211, and as will be discussed in greater detail below, processing device 224 is configured to determine of components, such as transceiver 204 and transceiver 205, should be woken up based on the received audio signal.

It will be appreciated that while such audio signal processing operations have been described as performed by processing device 224, processor 214 may also be configured to perform such audio signal processing operations. Accordingly, processor 214 may be configured to determine if components, such as transceiver 204 and transceiver 205, should be woken up based on the received audio signal.

In various embodiments, processing device 224 additionally includes processing elements configured to implement one or more layers underlying the previously discussed communications protocols. For example, processing device 224 may be configured to implement the Bluetooth protocol and the UWB protocol for transceiver 204 and transceiver 205. For example, processing device 224 may include processing elements configured to implement the Bluetooth protocol via a Bluetooth stack in which software is implemented as a stack of layers, and such layers are configured to compartmentalize specific functions utilized to implement the Bluetooth communications protocol. In various embodiments, a host stack includes layers for a Bluetooth network encapsulation protocol, radio frequency communication, service discovery protocol, as well as various other high level data layers. Moreover, a controller stack includes a link management protocol, a host controller interface, a link layer which may be a low energy link layer, as well as various other timing critical layers. Similarly, processing device 224 may include processing elements configured to implement the UWB protocol via a UWB layer stack as defined by the UWB protocol.

System 200 further includes radio frequency (RF) circuit 202 which is coupled to antenna 221 and antenna 222. In various embodiments, RF circuit 202 may include various components such as an RF switch, a diplexer, and a filter. Accordingly, RF circuit 202 may be configured to select an antenna for transmission/reception, and may be configured to provide coupling between the selected antenna, such as antenna 221 or antenna 222, and other components of system 200 via a bus, such as bus 211. While one RF circuit is shown, it will be appreciated that wireless device 201 may include multiple RF circuits. Accordingly, each of multiple antennas may have its own RF circuit. Moreover, each one may be associated with a particular wireless communications protocol, such as a first antenna and RF circuit for UWB and a second antenna and RF circuit for Bluetooth.

System 200 includes memory system 208 which is configured to store one or more data values associated with audio signal detection and validation operations discussed in greater detail below. Accordingly, memory system 208 includes storage device, which may be a non-volatile random-access memory (NVRAM) configured to store such data values. In various embodiments, system 200 further includes processor 214 which is configured to implement processing operations implemented by system 200. For example, as will be discussed in greater detail below, processor 214 may be configured to perform one or more secure ranging operations once wakeup operations have been performed.

It will be appreciated that one or more of the above-described components may be implemented on a single chip, or on different chips. For example, transceiver 204, transceiver 205, and processing device 224 may be implemented on the same integrated circuit chip, such as integrated circuit chip 220. In another example transceiver 204, transceiver 205, and processing device 224 may each be implemented on their own chip, and thus may be disposed separately as a multi-chip module or on a common substrate such as a printed circuit board (PCB).

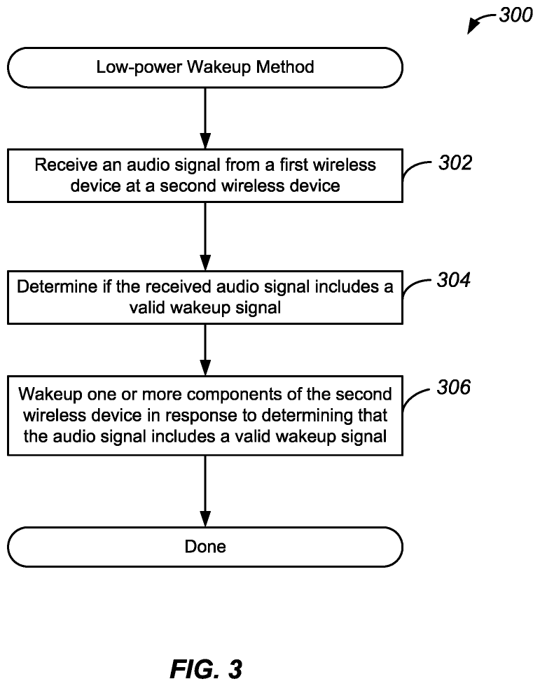

FIG. 3 illustrates an example of a method for low-power wakeup operations, performed in accordance with some embodiments. As will be discussed in greater detail below, methods, such as method 300, may be performed to implement security and authentication operations that may be used to, for example, grant or deny access to a particular operational environment associated with wireless devices. More specifically, method 300 may be performed by using low-power components to trigger secure ranging operations thus reducing overall power consumption of wireless devices.

Method 300 may perform operation 302 during which an audio signal may be received from a first wireless device at a second wireless device. In various embodiments, the audio signal may be transmitted from a transducer included in a wireless environment. For example, a transducer included in a sound-based ranging system may be configured to transmit an audio signal that includes an encoded set of data values that may be used for the purposes of authentication. Moreover, as similarly discussed above, the audio signal may be transmitted on a designated frequency channel which may be inaudible to human users.

Method 300 may perform operation 304 during which it may be determined if the received audio signal includes a valid wakeup signal. Accordingly, the second wireless device may receive the audio signal via, for example, a passive transducer, and may decode the encoded data values to determine if the encoded data values include a valid wakeup code. As will be discussed in greater detail below, the valid wakeup code may be a designated challenge code that may be generated via a public/private key pairing, or a user-generated security code.

Method 300 may perform operation 306 during which one or more components of the second wireless device may be woken up in response to determining that the audio signal includes a valid wakeup signal. Accordingly, in response to determining that the encoded data values are valid, one or more components of the second wireless device may be woken up. Accordingly, one or more transceivers may be transitioned from a sleep mode to a wake mode. In various embodiments, a power domain associated with a transceiver used for secure ranging operations may be transitioned to a wake mode, and secure ranging operations may commence to determine if access should be granted to the wireless environment.

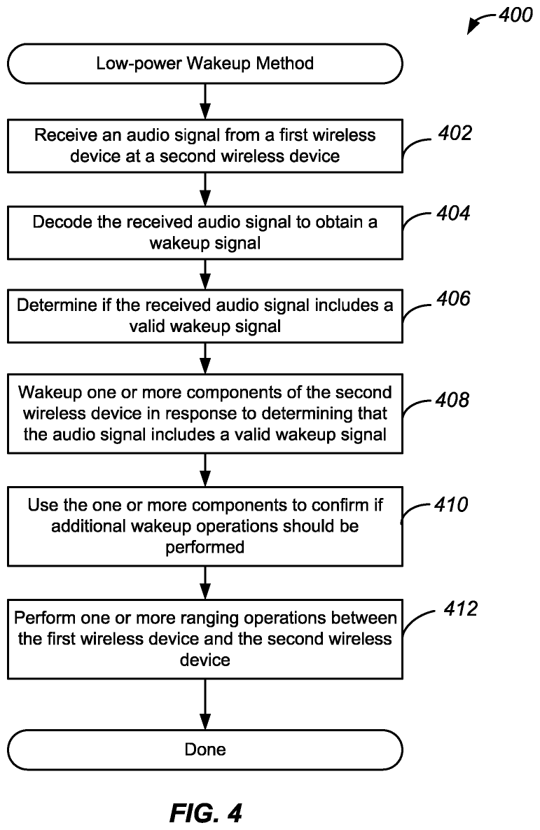

FIG. 4 illustrates another example of a method for low-power wakeup operations, performed in accordance with some embodiments. As will be discussed in greater detail below, methods, such as method 400, may be performed to implement security and authentication operations that may be used to, for example, grant or deny access to a particular operational environment associated with wireless devices. More specifically, method 400 may be performed to determine if components of such wireless devices should be used to perform operations underlying the grant or denial of access to vehicles, such as automobiles.

Method 400 may perform operation 402 during which an audio signal may be received from a first wireless device at a second wireless device. As similarly discussed above, the audio signal may be transmitted from a transducer included in a wireless environment. More specifically, the transducer may be a speaker or microphone included in an automobile. Accordingly, the transducer may be an existing component of the automobile used for other purposes that is also configured to transmit an audio signal disclosed herein. In one example, the transducer is included in a sonar system of an automobile that is used for parking assistance and object detection. Accordingly, the transducer may be configured to transmit an audio signal at a frequency higher than those audible by a human user. The operation of the transducers of the sonar system may be controlled via a processing device included in, for example, the head unit. Accordingly, the processing device of the head unit may be configured to also use the transducers of the sonar system to transmit the audio signal based on one or more operational parameters, such as the automobile being parked and turned off.

As similarly discussed above, the audio signal includes an encoded set of data values that may be used for the purposes of authentication. For example, the audio signal may be configured to encode a set of data values, as may be determined by a challenge code. In some embodiments, the challenge code may be determined based on pairing token associated with the first wireless device and the second wireless device. In one example, the challenge code may be determined based on a public/private key such as Elliptic Curve Diffie-Hellman Key Exchange (ECDH). In another example, the challenge code may be determined by an entity, such as a user or manufacturer, and may be stored as one or more types of data values. For example, the challenge code may be a user defined alphanumeric sequence, or may be a spoken pass phrase. In this way, a user may generate the challenge code during an initial calibration and setup procedure. The challenge code may be encoded via one or more audio encoding techniques and algorithms such as pulse-width modulation, phase modulation, and amplitude modulation. Moreover, as similarly discussed above, the audio signal may be transmitted on a designated frequency channel which may have been determined by an entity, such as a manufacturer, such that the first wireless device and the second wireless device are both configured to be capable of communication at the designated frequency channel.

Method 400 may perform operation 404 during which the received audio signal may be decoded to obtain a wakeup signal. Accordingly, the received audio signal may be decoded to extract the encoded data values identifying the challenge code. As discussed above, one or more encoding techniques may have been used for the audio signal. Thus, the second wireless device may include a decoder, and the decoder may be used to decode and extract the challenge code from the audio signal. As similarly discussed above, the second wireless device may be a key fob associated with an automobile. Accordingly, during operation 404, the audio signal may be received from the automobile at the key fob, and a decoder included in the key fob may be used to obtain a challenge code from audio data received from the automobile.

Method 400 may perform operation 406 during which it may be determined if the received audio signal includes a valid wakeup signal. Accordingly, the decoded data values may be used to determine if the challenge code is a valid challenge code and thus should trigger one or more wakeup operations. In various embodiments, such a determination may be made based on a type of challenge code that is used. For example, if a public/private key pairing is used, a private key used by the key fob may be used to authenticate the challenge code received from the automobile. In another example, if a designated passcode or passphrase has been previously determined, the received passcode or passphrase may be compared against one stored at the key fob to determine if they match. Accordingly, if it is determined that the challenge code is not valid, method 400 may terminate. However, if it is determined that the challenge code is valid, method 400 may proceed to operation 408.

Method 400 may perform operation 408 during which one or more components of the second wireless device may be woken up in response to determining that the audio signal includes a valid wakeup signal. Accordingly, in response to determining that the encoded data values are valid, one or more components of the second wireless device may be woken up. In the example where the second wireless device is a key fob associated with the automobile, one or more transceivers of the key fob may be transitioned from a sleep mode to a wake mode. In various embodiments, a power domain associated with a Bluetooth transceiver used by the key fob for secure ranging operations may be transitioned to a wake mode.

Method 400 may perform operation 410 during which the one or more components may be used to confirm if additional wakeup operations should be performed. In some embodiments, a processing device included in the second wireless device may include secure processing elements that are used for authentication operations underlying the secure-ranging operations. Accordingly, during operation 410, in response to determining that the challenge code is valid, the secure processing elements may be transitioned from a sleep mode to a wake mode. In some embodiments, the secure processing elements may be implemented as part of a separate power domain or a separate processing device.

Method 400 may perform operation 412 during which one or more ranging operations may be performed between the first wireless device and the second wireless device. Accordingly, the first wireless device may transmit an advertisement frame including advertisement parameters, and the second wireless device may actively scan in accordance with scanning parameters. Once a wireless connection has been established, the wireless connection may be encrypted. In various embodiments, such encryption may be performed in accordance with a wireless communications protocol. For example, if the wireless connection is a Bluetooth connection, the encryption may be performed via a Bluetooth authentication standard.

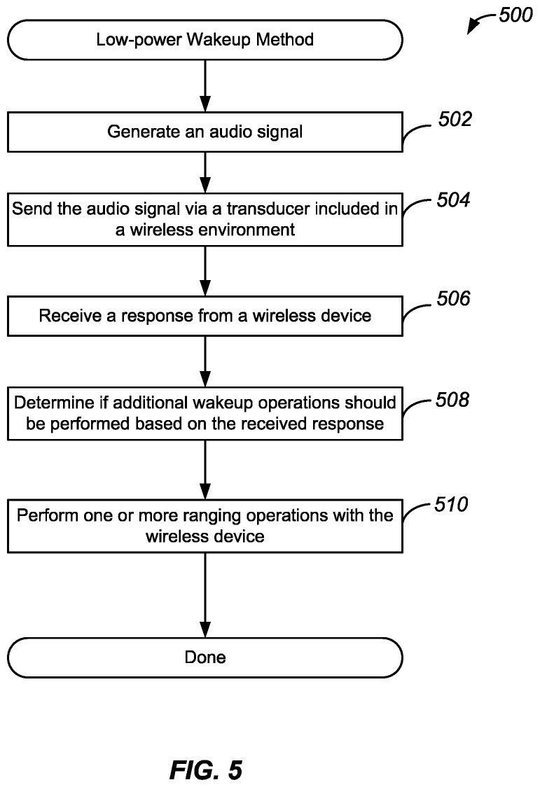

FIG. 5 illustrates an additional example of a method for low-power wakeup operations, performed in accordance with some embodiments. As will be discussed in greater detail below, methods, such as method 500, may be performed to implement security and authentication operations that may be used to, for example, grant or deny access to a particular operational environment associated with wireless devices. More specifically, method 500 may be performed to determine if components of such wireless devices should be used to perform operations underlying the grant or denial of access to vehicles, such as automobiles.

Method 500 may perform operation 502 during which an audio signal may be generated. As similarly discussed above, the audio signal may include an encoded set of data values that may be used for the purposes of authentication. For example, the audio signal may be configured to encode a set of data values, as may be determined by a challenge code. The challenge code may be encoded via one or more encoding techniques such as pulse-width modulation, phase modulation, and amplitude modulation. Accordingly, during operation 502, one or more components of a wireless environment, such as a head unit of an automobile, may be configured to generate an audio signal that includes an encoded challenge code.

Method 500 may perform operation 504 during which the audio signal may be sent via a transducer included in a wireless environment. Accordingly, the audio signal generated during operation 502 may be transmitted from a transducer included in the wireless environment. As similarly discussed above, the transducer may be a speaker or microphone included in an automobile. Accordingly, the transducer may be an existing component of the automobile used for other purposes that is also configured to transmit an audio signal disclosed herein. In one example, the transducer is included in a sonar system of an automobile that is used for parking assistance and object detection. Moreover, the operation of the transducers of the sonar system may be controlled via a processing device included in, for example, the head unit. Accordingly, the processing device of the head unit may be configured to also use the transducers of the sonar system to transmit the audio signal based on one or more operational parameters, such as the automobile being parked and turned off.

Method 500 may perform operation 506 during which a response may be received from a wireless device. Accordingly, the audio signal may be transmitted periodically as a beacon, and in response to receiving the audio signal, a wireless device, such a key fob, may generate and provide a response via a wireless connection. In this way, the challenge code is encoded and sent from the wireless environment, which may be an automobile, via an audio signal, and a reply is generated by the responding wireless device, which may be a key fob, and sent via a wireless connection, such as a Bluetooth connection or a UWB connection.

Method 500 may perform operation 508 during which it may be determined if additional wakeup operations should be performed based on the received response. In some embodiments, a processing device included in a component of the wireless environment, such as the head unit, may include secure processing elements that are used for authentication operations underlying the secure-ranging operations. Accordingly, during operation 508, in response to receiving a valid reply to the audio signal via the wireless connection, the secure processing elements may be transitioned from a sleep mode to a wake mode. In some embodiments, the secure processing elements may be implemented as part of a separate power domain or a separate processing device.

Method 500 may perform operation 510 during which one or more ranging operations may be performed with the wireless device. Accordingly, an advertisement frame including advertisement parameters may be transmitted from the wireless environment, and the wireless device may actively scan in accordance with scanning parameters. Once a wireless connection has been established, the wireless connection may be encrypted. As similarly discussed above, the wireless connection may be encrypted in accordance with a wireless communication protocol, such as a Bluetooth protocol and authentication standard.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
receiving an audio signal from a first wireless device at a second wireless device via an audio transducer, the audio signal comprising a plurality of encoded data values;
determining, using a processing device of the second wireless device, if the received audio signal includes a valid wakeup code; and
transitioning a transceiver of the second wireless device from a sleep mode to a wake mode in response to determining that the audio signal includes a valid wakeup signal.

2. The method of claim 1, wherein the first wireless device is a head unit included in an automobile, and wherein the second wireless device is a key fob.

3. The method of claim 1, wherein the audio transducer is a microelectromechanical systems (MEMS) microphone.

4. The method of claim 1, wherein the plurality of encoded data values comprises a challenge code encoded via one or more audio encoding algorithms.

5. The method of claim 4, wherein the challenge code is generated based, at least in part, on a pairing token associated with the first wireless device and the second wireless device.

6. The method of claim 1, wherein the transceiver is a Bluetooth transceiver or an ultrawideband (UWB) transceiver.

7. The method of claim 1 further comprising:
transitioning a plurality of secure processing elements of the second wireless device from a sleep mode to a wake mode in response to determining that the audio signal includes a valid wakeup signal.

8. The method of claim 1 further comprising:
performing, using the transceiver, a secure ranging operation with the first wireless device in accordance with a wireless protocol of the transceiver.

9. The method of claim 8 further comprising:
granting access to a vehicle associated with the first wireless device in response to completion of the secure ranging operation.

10. A system comprising:
an audio transducer;
a transceiver configured to be compatible with a wireless protocol; and
a processing device comprising processing elements configured to:
receive an audio signal from a first wireless device at a second wireless including the processing device, the audio signal being received via the audio transducer and comprising a plurality of encoded data values;
determine if the received audio signal includes a valid wakeup code; and
transition the transceiver from a sleep mode to a wake mode in response to determining that the audio signal includes a valid wakeup signal.

11. The system of claim 10, wherein the first wireless device is a head unit included in an automobile, and wherein the second wireless device is a key fob.

12. The system of claim 10, wherein the audio transducer is a microelectromechanical systems (MEMS) microphone, and wherein the transceiver is a Bluetooth transceiver or an ultrawideband (UWB) transceiver.

13. The system of claim 10, wherein the plurality of encoded data values comprises a challenge code encoded via one or more audio encoding algorithms, and wherein the challenge code is generated based, at least in part, on a pairing token associated with the first wireless device and the second wireless device.

14. The system of claim 10, wherein the processing device is further configured to:
transition a plurality of secure processing elements of the second wireless device from a sleep mode to a wake mode in response to determining that the audio signal includes a valid wakeup signal.

15. The system of claim 10, wherein the processing device is further configured to:
perform a secure ranging operation with the first wireless device in accordance with a wireless protocol of the transceiver.

16. A device comprising:
processing elements configured to:
receive an audio signal from a first wireless device at a second wireless including the processing elements, the audio signal being received via an audio transducer and comprising a plurality of encoded data values;
determine if the received audio signal includes a valid wakeup code; and
transition a transceiver of the second wireless device from a sleep mode to a wake mode in response to determining that the audio signal includes a valid wakeup signal.

17. The device of claim 16, wherein the first wireless device is a head unit included in an automobile, and wherein the second wireless device is a key fob.

18. The device of claim 16, wherein the audio transducer is a microelectromechanical systems (MEMS) microphone, and wherein the transceiver is a Bluetooth transceiver or an ultrawideband (UWB) transceiver.

19. The device of claim 16, wherein the plurality of encoded data values comprises a challenge code encoded via one or more audio encoding algorithms, and wherein the challenge code is generated based, at least in part, on a pairing token associated with the first wireless device and the second wireless device.

20. The device of claim 16, wherein the processing elements are further configured to:
transition a plurality of secure processing elements of the second wireless device from a sleep mode to a wake mode in response to determining that the audio signal includes a valid wakeup signal.
